(19) United States
(12) Patent Application Publication
(10) Pub. No.: US 2014/0199583 A1
(43) Pub. Date: Jul. 17, 2014

(54) ELECTRODE FOR NONAQUEOUS ELECTROLYTE SECONDARY BATTERY, NONAQUEOUS ELECTROLYTE SECONDARY BATTERY, AND BATTERY PACK

(71) Applicant: KABUSHIKI KAISHA TOSHIBA, Tokyo (JP)

(72) Inventors: Asato KONDO, Kanagawa (JP); Takashi KUBOKI, Tokyo (JP)

(73) Assignee: KABUSHIKI KAISHA TOSHIBA, Tokyo (JP)

(21) Appl. No.: 14/215,926

(22) Filed: Mar. 17, 2014

Related U.S. Application Data
(63) Continuation of application No. PCT/JP2012/057833, filed on Mar. 26, 2012.

(51) Int. Cl. H01M 4/131; H01M 4/136; H01M 4/62; H01M 10/0525

(52) U.S. Cl. CPC H01M 4/131; H01M 10/0525; H01M 4/136; H01M 4/623
USPC 429/163; 429/211

(57) ABSTRACT

An electrode for a nonaqueous electrolyte secondary battery of an embodiment has an active material layer containing an active material and a binder containing fluorine, and a current collector bound to the active material layer. When a thermal decomposition start temperature of the binder is T1° C. and the thermal decomposition end temperature is T2° C., one or more signals are present for any of the mass number of 81, 100, 132, and 200 in a thermal decomposition mass analysis between thermal decomposition temperatures of T1 and T2. When a signal area of the mass spectrum in the range of T1-100° C. or higher but lower than T1° C. is X, and a signal area of the mass spectrum in the range of T1 or higher but the same or lower than T2° C. is Y, the X and Y satisfy a relation of X≦Y.

### CROSS-REFERENCE TO RELATED APPLICATION

This application is a continuation application based upon and claims the benefit of priority from International Application PCT/JP2012/057833, the International Filing Date of which is Mar. 26, 2012 the entire contents of which are incorporated herein by reference.

### FIELD

Embodiments described herein relate generally to an electrode for a nonaqueous electrolyte secondary battery, a nonaqueous electrolyte secondary battery, and a battery pack.

### BACKGROUND

A nonaqueous electrolyte secondary battery represented by a lithium ion secondary battery has higher energy density than an aqueous electrolyte secondary battery such as nickel hydrogen secondary battery. Thus, it is used in many fields including a small portable device such as a PC or a smart phone, and a large power source including an electric vehicle and a power source for power smoothing, and obtainment of even higher energy density is desired. An electrode for a non-aqueous secondary battery has a structure in which an active material is supported, with a binder/a conductive material, on a current collector.

Present inventors found that, when an electrode is manufactured with an active material and evaluated as a battery, the discharge capacity is lowered compared to a case where particles of an active material are evaluated by themselves. Although the reaction mechanism relating to deterioration of the discharge capacity of an active material is not completely clearly defined, the following reaction mechanism has been suggested, for example.

An electrode of a nonaqueous electrolyte solution is produced by kneading an active material for a positive electrode and a negative electrode with a binder and supporting them on a current collector. During a drying process after supporting, there is a possibility that the binder reacts with the active material to lower the discharge capacity of the active material. Further, although an organic polymer material is used as a binder, there is also possibility that, as the binder is swollen with an organic solvent constituting the nonaqueous electrolyte during the use of a battery for a long period time, the binding strength between the active material and conductive material is lowered, yielding lower capacity accompanied with increased resistance.

### BRIEF DESCRIPTION OF THE DRAWINGS

FIG. 1 is a schematic diagram illustrating a negative electrode active material of an embodiment.

FIG. 2 is a graph illustrating a thermogravimetry of PVdF.

FIG. 3 is a graph of total ion chromatogram of thermogravimetric mass spectrometry of a positive electrode active material layer of an embodiment.

FIG. 4 is a schematic diagram illustrating the nonaqueous electrolyte secondary battery of an embodiment.

FIG. 5 is an enlarged schematic diagram illustrating the nonaqueous electrolyte secondary battery of an embodiment.

FIG. 6 is a schematic diagram illustrating a battery pack of an embodiment.

FIG. 7 is a block diagram illustrating an electric circuit of the battery pack.

### DETAILED DESCRIPTION

An electrode for a nonaqueous electrolyte secondary battery of an embodiment comprises an active material layer containing an active material and a binder containing fluorine and a current collector bound to the active material layer. When a thermal decomposition start temperature of the binder is T1° C. and the thermal decomposition end temperature is T2° C., one or more signals are present for any of the mass number of 81, 100, 132, and 200 in a thermal decomposition mass analysis between thermal decomposition temperatures of T1 and T2. When a signal area of the mass spectrum in the range of T1-100° C. or higher but lower than T1° C. is X, and a signal area of the mass spectrum in the range of T1 or higher but the same or lower than T2° C. is Y, the X and Y satisfy a relation of X≦Y. The thermal decomposition start temperature of the binder indicates, in a main weight loss process, a temperature at which 5% of the weight loss portion in the weight loss process is reduced when the binder is analyzed by thermogravimetric analysis. The thermal decomposition end temperature of the binder indicates, in a main weight loss process, a temperature at which 95% of the weight loss portion in the weight loss process is reduced when the binder is analyzed by thermogravimetric analysis. The signal area of mass spectrum indicates, in the mass spectrum of the binder, signal area of the mass number with maximum signal area between T1 and T2 among one or more signals selected from the mass number of 81, 100, 132, and 200.

A nonaqueous electrolyte secondary battery of an embodiment comprises a negative electrode, a positive electrode, a nonaqueous electrolyte layer formed between the positive electrode and negative electrode, and a case for accommodating the positive electrode, the negative electrode, and an electrolyte. At least one of the positive electrode and negative electrode is above electrode of an embodiment.

A battery pack of an embodiment comprises a nonaqueous electrolyte secondary battery of an embodiment.

Hereinbelow, the embodiments are described with reference to the drawings.

### First Embodiment

As a first embodiment, a case where the electrode is a positive electrode is described as an example.

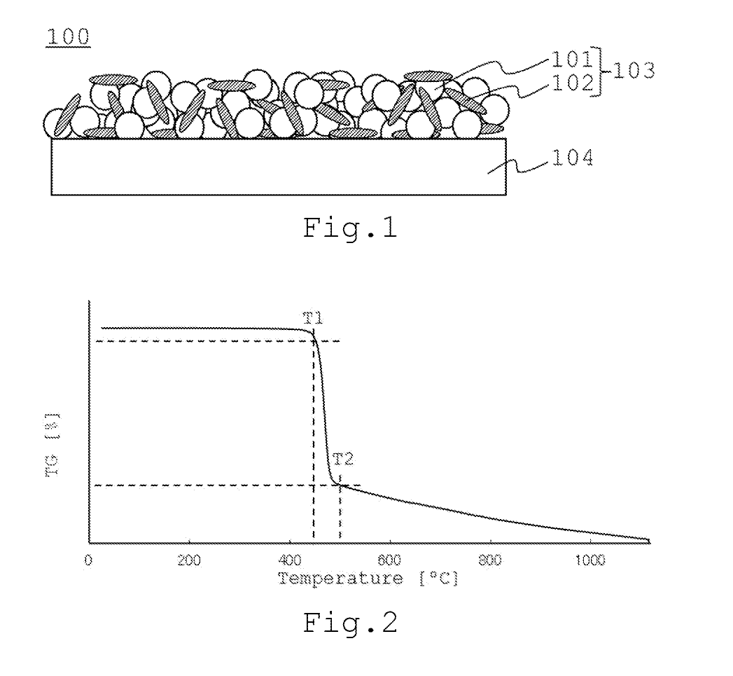

As illustrated in the schematic diagram of FIG. 1, a positive electrode 100 of the first embodiment has a positive electrode active material 101, a sheet-like positive electrode active material layer 103 containing a binder 102 for binding the positive electrode active material 101, and a current collector 104 bound to the positive electrode active material layer 103. The positive electrode active material layer 103 is formed on a single surface or both surfaces of the current collector 104. Hereinbelow, except a case where references are made to the drawings, the numerals are abbreviated. Meanwhile, it is also possible that an active material for a negative material can be used instead of the positive electrode active material 101 and the electrode of an embodiment is a negative electrode.

The positive electrode active material of the embodiment carries out insertion and removal of Li. As for the positive electrode active material, it is not particularly limited if it is a positive electrode active material used for a nonaqueous electrolyte secondary battery. Examples thereof include a lithium composite oxide or lithium composite phosphate compound containing lithium and a metal other than lithium, a conductive polymer such as polyaniline or polypyrrole, a disulfide-based polymer containing sulfur, and carbon fluoride.

Examples of the metal other than lithium, which is contained in the composite oxide containing lithium and a metal other than lithium, include at least one metal selected from Fe, Ni, Co, Mn, V, Al, and Cr.

Examples of the composite oxide containing Mn which may be used include LiMn₂O₄ and Li₍₁₊ₓ₎Mn_{(2-x-y)}M_{y}O_{z} (0≦x≦0.2, 0≦y≦1.1, 3.9≦z≦4.1, and M is at least one element selected from Ni, Co, and Fe).

Examples of the composite oxide containing Ni include Li(NiₓM_{y})O₂ (x+y=1, 0<x≦1, 0≦y<1, and M is at least one element selected from Co and Al).

Examples of the composite oxide containing V or Cr include LiVO₂ and LiCrO₂.

Examples of the lithium composite phosphate compound include a composite phosphate compound represented by LiCoPO₄, LiMnPO₄, LiFePO₄, Li(FeₓM_{y})PO₄ (x+y=1, 0<x<1, and M is at least one element selected from Co and Mn), or Li(CoₓMn_{y})PO₄ (x+y=1, 0<x<1).

Among them, the positive electrode active material which has charge end voltage of 4.0 V or higher against the lithium reference potential (hereinbelow, described as (Li/Li+)) is preferable in that it exhibits a high effect of the present embodiment. As a composite oxide containing Mn, LiMn₂O₄ or Li₍₁₊ₓ₎Mn_{(2-x-y)}M_{y}O_{z} (0≦x≦0.2, 0≦y≦1.1, 3.9≦z≦4.1, and M is at least one element selected from Ni, Co, and Fe) can be used. More specific examples thereof include LiMn_{1.5}Ni_{0.5}O₄, LiMn_{1.5}Cu_{0.5}O₄, LiMnFeO₄, LiMn_{1.5}Fe_{0.5}O₄, LiMnCoO₄, Li(Ni_{1/3}Co_{1/3}Mn_{1/3})O₂, Li(Ni_{5/10}Co_{2/10}Mn_{3/10})O₂, Li(Ni_{6/10}Co_{2/10}Mn_{2/10})O₂, and Li(Ni_{5/10}Co_{1/10}Mn_{1/10})O₂. Further, as a composite oxide containing Ni, Li(NiₓM_{y})O₂ (x+y=1, 0<x≦1, 0≦y<1, and M is at least one element selected from Co and Al) can be used. More specific examples thereof include LiNiO₂, LiCo_{0.5}Ni_{0.5}O₂, LiNi_{0.9}Al_{0.1}O₂, and LiNi_{0.8}Co_{0.1}Al_{0.1}O₂.

Further, the positive electrode active material which has charge end voltage of 4.8 V or higher against Li/Li+ is preferable in that it exhibits a high effect of the present embodiment. Specifically, as a lithium composite oxide, Li₍₁₊ₓ₎Mn_{(2-x-y)}M_{y}O_{z} (0≦0.2, 0≦y≦1.1, 3.9≦z≦4.1, and M is at least one element selected from Ni, Co, and Fe) can be used. More specific examples thereof include LiMn_{1.5}Ni_{0.5}O₄, LiMn_{1.5}Co_{0.5}O₄, LiMnFeO₄, LiMn_{1.5}Fe_{0.5}O₄, LiMnCoO₄, Li(Ni_{1/3}Co_{1/3}Mn_{1/3})O₂, Li(Ni_{5/10}Co_{2/10}Mn_{3/10})O₂, Li(Ni_{6/10}Co_{2/10}Mn_{2/10})O₂, and Li(Ni_{8/10}Co_{1/10}Mn_{1/10})O₂. Further, as a lithium composite phosphate compound, a lithium composite phosphate compound represented by Li(FeₓM_{y})PO₄ (x+y=1, 0≦x<0.5, and M is at least one element selected from Co and Mn) or Li(CoₓMn_{y})PO₄ (x+y=1, 0<x<1) can be used.

Shape of the positive electrode active material is preferably particulate shape. Further, the average diameter of the particulate positive electrode active material is in the range of 1 nm to 100 μm, and preferably in the range of 10 nm to 30 μm. Further, a specific surface area of the particulate positive electrode active material is preferably in the range of 0.1 m²/g to 10 m²/g, for example.

The positive electrode active material may be used either singly or as a mixture of two or more types, and an organic material-based active material such as conductive polymer material or disulfide-based polymer material can also be incorporated thereto.

The binder of the embodiment is a material capable of providing an excellent binding property among positive electrode active materials and an excellent binding property between a positive electrode active material layer and a current collector. As for the binder, a polymer material containing fluorine can be used. Since the polymer material containing fluorine has excellent resistance to oxidation/reduction, it can provide a cell with excellent service life characteristics. Further, the binder preferably contains, as a raw material, at least one compound selected from vinylidene difluoride, tetrafluoroethylene, polychlorotrifluoroethylene, polyvinyl fluoride, ethylene, tetrafluoroethylene copolymer, hexafluoropropene, polyfluorovinylidene-hexafluoropropene copolymer, and polytetrafluoroethylene-hexafluoropropene copolymer. The fluororesin having them as a raw material is not dissolved in an electrolyte solution, and therefore preferable. Among them, vinylidene difluoride, tetrafluoroethylene, and hexafluoropropene are preferable. Specific examples of the fluororesin include polytetrafluoroethylene (PTFE), polyvinyldiene difluoride (PVdF), polytetrafluoroethylene-vinylidene fluoride (PTFE-PVdF), and polyetetrafluoroethylene-hexafluoropropylene (PTFE-HFP). Further, being difficult to be swollen in a nonaqueous electrolyte, PTFE and PVdF are preferable. Among them, PVdF can be dissolved in an organic solvent such as N-methylpyrrolidone (NMP), allowing easy manufacture of an electrode, and therefore preferable.

The positive electrode active material layer is, as a mixture containing a positive electrode active material and a binder, bound to a current collector. In the positive electrode active material layer, a conductive material may be added for the purpose of enhancing conductivity of a negative electrode, in addition to the positive electrode active material and a binder. The conductive material to be used is not particularly limited if it is a conductive material and is not decomposed or dissolved when the battery is used. Examples of those which may be used include a carbon material such as acetylene black, carbon black, graphite, vapor grown carbon fiber (VGCF), or carbon nanotube, a metal material such as aluminum or titanium, a conductive ceramic material, and a conductive glass material.

To have a positive electrode active material containing an active material and a binder containing fluorine in which, when the thermal decomposition start temperature of the binder is T1° C. and the thermal decomposition end temperature is T2° C., one or more signals are present for any of the mass number of 81, 100, 132, and 200 in a thermal decomposition mass analysis between thermal decomposition temperatures of T1 and T2, and, when a signal area of the mass spectrum in the range of T1-100° C. or higher but lower than T1° C. is X and a signal area of the mass spectrum in the range of T1 or higher but the same or lower than T2° C. is Y, the X and Y satisfy a relation of X≦Y, the amount of the binder present far from the positive electrode active material is preferably higher than the amount of the binder present near the positive electrode active material. The binder containing fluorine is easily decomposed when heated in the presence of a positive electrode active material. When the binder containing fluorine is decomposed, corrosive HF gas is generated. Because the positive electrode active material may be deteriorated by the corrosive gas during heating and drying process for manufacturing an electrode, the positive electrode containing the positive electrode active material and binder preferably satisfies the following condition for thermal decomposition mass ratio.

The thermal decomposition temperature of a binder is lowered when it is brought in contact with a positive electrode active material. Thus, the binder covering the active material is easily decomposed. When the positive electrode active material layer containing an active material and a binder containing fluorine is heated by a thermogravimetric mass analyzer, the binder melts before an occurrence of main weight loss. During the process of main weight loss, the binder covering the active material is decomposed/gasified to yield voids. Meanwhile, the binder present near the active material and not covering the active material is melt and migrates to the newly formed voids to be in contact with the active material and then decomposed/gasified in order. Specifically, when a thermal decomposition mass analysis is performed by having the thermal decomposition temperature as a reference, the amount of the binder not covering the positive electrode active material but present near the material can be assessed in addition to the binder covering the positive electrode active material, and accordingly, it is possible to evaluate whether or not the positive electrode active material has decomposition-prone form.

The thermal decomposition temperature can be measured by thermal gravimetric mass analysis tester (TG-MS) allowing simultaneously the thermal gravimetric analysis and the mass analysis of generated gas. The atmosphere for measurement is not particularly limited if it is under non-oxidizing atmosphere. For example, inert gas such as helium, argon, or nitrogen can be used.

The weight loss process which is excluded for the calculation of thermal decomposition temperature corresponds to a weight loss process at low temperature side in which moisture or carbon oxide adsorbed during storage of the binder is released, and it can be determined by using a TG-MS analyzer or EGA-MS analyzer. The residual weight which is excluded for the calculation of thermal decomposition end temperature is derived from a material hardly observed with any weight loss under inert gas atmosphere, that is, carbon or a tar component generated by thermal decomposition of the binder or a ceramic material either incorporated or added during production process, and it can be identified as an independent broad peak or slope, while the main weight loss process is observed as a strong peak when TG, TG-MS, and EGA-MS measurement is performed. Further, a minor peak with small weight loss process other than the weight loss processes excluded at low temperature side and high temperature side corresponds to a peak or a slope responsible for a change of less than 5% by weight of a sample for measurement. The thermal decomposition start temperature of the binder indicates, in a main weight loss process, a temperature at which 5% of the weight loss portion in the weight loss process is reduced when the binder is analyzed by thermogravimetric analysis. The thermal decomposition end temperature of the binder indicates, in a main weight loss process, a temperature at which 95% of the weight loss portion in the weight loss process is reduced when the binder is analyzed by thermogravimetric analysis.

First, explanations of the thermal decomposition temperature as a reference are given with reference to a thermogravimetric analysis of PVdF alone of FIG. 2, which does not contain the active material. In TG-MS, the start and end temperatures of thermal decomposition are determined by observing weight loss amount of a binder when the temperature is increased from room temperature (25° C.) to 1000° C. PVdF showed weight loss of 2% in the range of room temperature (25° C.) to 200° C. but showed no weight loss in the range of 200° C. to 400° C. After that, it showed weight loss of 3.5% in 400° C. to 450° C., 63% in 450° C. to 500° C., 3.5% in 500° C. to 520° C., and gradual weight loss thereafter to show a curved slope in thermogravimetic change graph. Thus, the main weight loss process in the thermogravimetric analysis of PVdF resides in the range of 400° C. to 520° C., and the thermal decomposition temperature T1 is 450° C. while the thermal decomposition end temperature T2 is 500° C. Based on this, it was found that the binder present far from the active material experiences thermal decomposition between T1 (450° C.) and T2 (500° C.) and the binder present near the active material experiences thermal decomposition at the temperature lower than T1 (450° C.). With regard to the thermal decomposition mass analysis at 475° C. corresponding to (T1+T2)/2, peaks with the mass number of 132 and 200 are present.

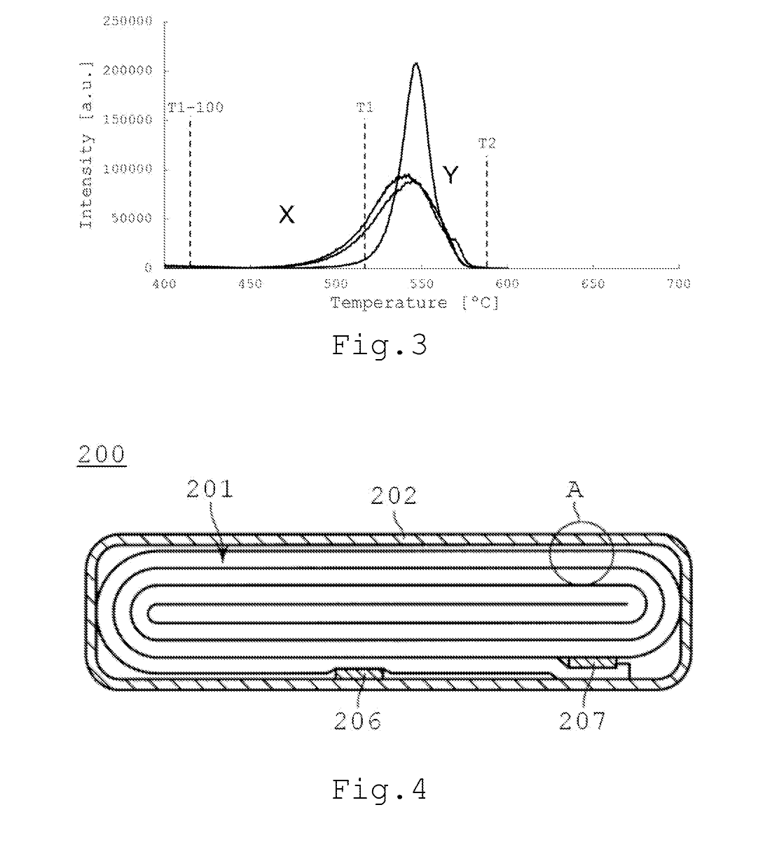

Next, with reference to a mass spectrum of an ion chromatogram of a positive electrode active material layer which contains the active material and binder of the embodiment illustrated in FIG. 3, the method of obtaining the ratio between the binder amount present near the positive electrode active material and the binder amount present far from the positive electrode active material is described. When subjected to a thermal decomposition mass analysis, the binder containing fluorine shows a signal with at least one mass number of mass number of 81, 100, 132, and 200, although it may vary depending on the compound constituting the binder. For the thermal decomposition mass analysis, an ion chromatogram from which the signal of mass number of 81, 100, 132, and 200, which are specific to the binder containing fluorine, is extracted by TG-MS, EGA-MS, Pyro-MS was used. From the mass spectrum obtained by ion chromatogram, the area of binder amount present near the positive electrode active material and the area of binder amount present far from the positive electrode active material are calculated. For area calculation, among one or more signals selected from the mass number of 81, 100, 132, and 200 in the mass spectrum of an ion chromatogram of a binder, the signal with the mass number having the highest signal area between T1 and T2 is used. In the mass spectrum of PVdF in an embodiment, the signal area with the mass number of 132 is the highest, and thus the signal area with the mass number of 132 is also obtained for the measurement of positive electrode active material layer. The signal area of the mass number of 132 in the range of T1-100° C. or higher but lower than T1° C. is X and the signal area of the mass number of 132 in the range of T1° C. or higher but the same or lower than T2° C. is Y. Meanwhile, in FIG. 3 used for the explanations, the area of the signal with the mass number of 132 was obtained since PVdF is used as a binder. However, for a case wherein the binder is PTFE or the like, X and Y may be obtained from the signal area with the mass number of 100 or the like.

In the positive electrode active material layer in which dispersion of the positive electrode active material and binder is controlled such that X and Y obtained according to the method satisfies the relation of X≦Y, the binder amount near the active material appears to be lower than the binder amount far from the active material. The mechanism of having improved discharge capacity as described above at X≦Y is not necessarily clear, but it is believed as follows. Because when the positive electrode active material is covered with the binder and the binder is heated while it is contact with the active material, it easily decomposes. Thus, in the electrode, the portion of the binder which covers the positive electrode active material to be in contact with it may be partially gasified to produce voids, thus yielding lower discharge capacity. In such case, it is believed that, when not only the binder covering the active material but also the binder in contact with the active material is reduced, a side reaction of the active material during the electrode manufacturing process is suppressed so that the discharge capacity is increased. There is also possibility that the remaining binder has increased in volume when it is swollen with an organic solvent constituting the nonaqueous electrolyte, and as a result, by filling the voids and contacting the positive electrode active state in filled state, it reacts with the active material to lower the discharge capacity. In such case, it is believed that not only the binder covering the active material but also the binder present near the active material is reduced to suppress the side reaction of the active material, and thus the discharge capacity can be increased.

X>Y represents that the binder amount near the active material is higher than the binder amount far from the active material. As described above, although the mechanism related to lower characteristics of the active material under the aforementioned conditions is not clear, the following reaction mechanism can be considered, for example. There is a possibility that, as the binder reacts with a positive electrode active material during the positive electrode drying process, the active material capacity is lowered. Alternatively, due to swelling of the binder with the organic solvent constituting the nonaqueous electrolyte, the binding force between the active material and conductive material is weakened and the capacity is lowered accompanied with increased resistance.

The mixing ratio of the positive electrode active material, conductive material, and binder in the positive electrode active material layer is preferably such that positive electrode active material is between 80% by mass and 95% by mass, the conductive material is between 3% by mass and 18% by mass, and the binder is between 2% by mass and 17% by mass. By adding the conductive material at 3% by mass or more, the effect of increasing the conductivity can be exhibited. By having at 18% by mass or less, having the discharge capacity lower than practically usable range can be prevented. By adding the binder at 2% by mass or more, sufficient binding strength is obtained. Further, with an amount of 17% by mass or less, having the high current discharge characteristics lower than practically usable range as caused by decreased conductivity can be prevented.

As for the current collector of the embodiment, a metal foil with no holes, a punched metal having many holes, and a metal mesh having fine metal line formed thereon can be used. The material of the current collector is not particularly limited if it is not dissolved in an environment in which a battery is used. Examples thereof which may be used include metal such as Al or Ti and an alloy containing those metals as a main component and added with at least one element selected from a group consisting of Zn, Mn, Fe, Cu, and Si. In particular, an aluminum alloy foil having Al as a main component is preferable in that it has an excellent molding property due to flexibility.

Next, explanations are given with regard to a method of producing a positive electrode of the embodiment.

The positive electrode is produced by mixing a positive electrode active material, a binder, and a conductive material followed by supporting them on a surface of a current collector. For example, it can be produced by suspending a positive electrode active material, a binder, and a conductive material in a suitable solvent, and coating the resulting suspension on an Al foil followed by drying and pressing. It can also be produced by mixing a positive electrode active material, a binder, and a conductive material in a solid state, pressing the obtained mixture on an Al alloy mesh followed by drying and pressing. Among them, the method of suspending a positive electrode active material, a binder, and a conductive material in an organic solvent such as NMP is preferable in that a homogeneous electrode can be manufactured.

The electrode of the embodiment can be obtained by, in the manufacturing process described above, decreasing the binder amount near the active material. For example, when a positive electrode active material, a binder, and a conductive material are mixed with one another, the binder and conductive material are kneaded first, and then the positive electrode active material is added thereto and kneaded. The kneading energy after adding the positive electrode active material is preferably lower than the energy for kneading the binder and conductive material. Controlling the kneading energy is carried out by modifying the conditions for operating a kneading apparatus or by modifying the apparatus itself. Examples of the conditions for operation include time, temperature, kneading wing/rotation speed of a container, or the like, and increasing the energy can be achieved by extending the kneading time, increasing the kneading temperature, and increasing the kneading wing/rotation speed of a container. Examples of the modification of an apparatus include adding beads for stirring and modification into an apparatus for responding to stirring in the presence of beads. Beads indicate a ceramic of metallic ball of 1 mm to 3 cm, and by adding them at kneading, aggregates of the solid matter can be disrupted.

Meanwhile, as the first embodiment, explanations are given for a case wherein the electrode is a positive electrode, but it is not limited thereto and it is needless to say that the application can be made to a case wherein the electrode is a negative electrode. The same shall apply to the embodiments described below.

### Second Embodiment

The nonaqueous electrolyte secondary battery according to the second embodiment is described.

The nonaqueous electrolyte secondary battery according to the second embodiment is equipped with a positive electrode, a negative electrode, a nonaqueous electrolyte layer formed between the positive electrode and negative electrode, and a case for accommodating the negative electrode, positive electrode, and electrolyte.

More detailed explanations are given with reference to the schematic diagram of FIG. 4 in which one example of the nonaqueous electrolyte secondary battery 200 according to the embodiment is illustrated. FIG. 4 is a cross-sectional schematic diagram of the flat type nonaqueous electrolyte secondary battery 200 in which the bag-like case 202 is made of a laminate film.

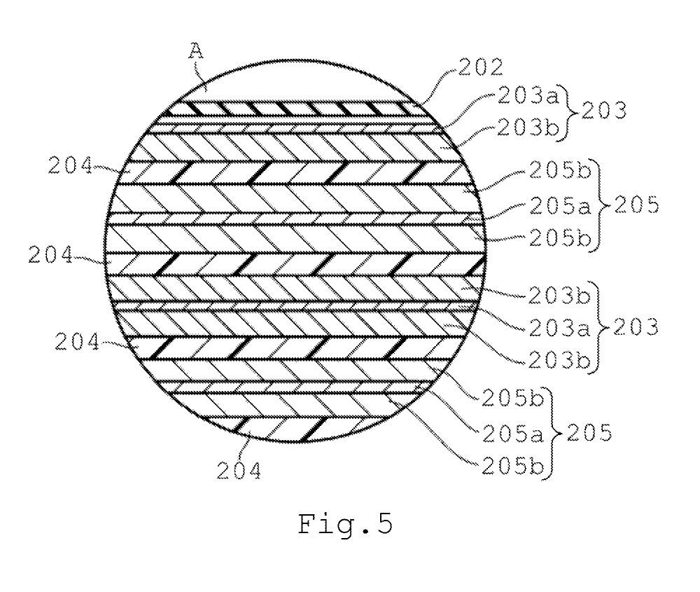

The flat shape wound electrode group 201 is accommodated in the bag-like case 202, which is made of a laminate film in which an aluminum foil is inserted between two pieces of a resin layer. In the flat shape wound electrode group 201, as illustrated in FIG. 5 as a schematic diagram for showing part of it, the negative electrode 203, the separator 204, the positive electrode 205, and the separator 204 are laminated in order. It is formed by winding the laminate in whirlpool shape and press molding. The electrode closest to the bag-like case 202 is a negative electrode, and the negative electrode has a constitution that the negative electrode active material layer is not formed on the negative electrode current collector on the bag-like case 202 but the negative electrode active material layer is formed on only a single surface of the inner side of the battery of the negative electrode current collector. The negative electrode 203 is also constituted by forming a negative electrode active material layer on both surfaces of the negative electrode current collector. The positive electrode 205 is constituted by forming a positive electrode active material layer on both surfaces of the positive electrode current collector.

Near the peripheral end of the wound electrode group 201, the negative electrode terminal is electrically connected to the negative electrode current collector of the outermost negative electrode 203, and the positive electrode terminal is electrically connected to the positive electrode current collector of the positive electrode 205 on inner side. The negative electrode terminal 206 and the positive electrode terminal 207 are extended from an opening of the bag-like case 202 to the outside. For example, a liquid phase nonaqueous electrolyte is injected via the opening of the bag-like case 202. By heat-sealing the opening of the bag-like case 202 having the negative electrode terminal 206 and the positive electrode terminal 207 between it, the wound electrode group 201 and the liquid phase nonaqueous electrolyte are completely sealed.

Examples of the negative electrode terminal include aluminum and an aluminum alloy containing an element like Mg, Ti, Zn, Mn, Fe, Cu, and Si. The negative electrode terminal has the same material as the negative electrode current collector to lower the resistance caused by contact with the negative electrode current collector.

As for the positive electrode terminal, it is possible to use a material having both the electric stability and conductivity in the range in which the potential against the lithium ion metal is 3 V to 4.25 V. Specific examples include aluminum and an aluminum alloy containing an element like Mg, Ti, Zn, Mn, Fe, Cu, and Si. The positive electrode terminal has the same material as the positive electrode current collector to lower the resistance caused by contact with the positive electrode current collector.

Hereinbelow, a bag-like case, a positive electrode, an electrolyte, and a separator, which are the constitutional member of a nonaqueous electrolyte secondary battery, are described in detail.

1) Bag-Like Case

The bag-like case is formed of a laminate film with a thickness of 0.5 mm or less. Alternatively, a metallic container with a thickness of 1.0 mm or less is used as a case. The metallic container preferably has thickness of 0.5 mm or less.

Shape of the bag-like case can be selected from a flat type (foil type), a polygon type, a cylinder type, a coin type, and a button type. Examples of the case include, depending on size of a battery, a case for small battery installed in a portable electronic device and a case for large battery installed in a two-wheel drive or a four-wheel drive vehicle.

As for the laminate film, a multilayer film in which a metal layer is inserted between resin layers is used. In order to have light weight, the metal layer is preferably an aluminum foil or an aluminum alloy foil. As for the resin layer, a polymer material such as polypropylene (PP), polyethylene (PE), nylon, or polyethylene terephthalate (PET) can be used. The laminate film can be molded to shape of a case by sealing under thermal fusion.

The metallic container is made of aluminum or aluminum alloy. The aluminum alloy is preferably an alloy containing an element such as magnesium, zinc, or silicon. When a transition metal such as iron, copper, nickel, or chrome is contained in the alloy, the amount is preferably 100 ppm by mass or lower.

2) Positive Electrode

As for the positive electrode, the positive electrode of the first embodiment is used.

3) Negative Electrode

The negative electrode includes a current collector and a layer containing the negative electrode active material, which is supported on a single surface or both surfaces of the current collector.

The negative electrode can be produced by suspending and mixing a negative electrode mixture containing a negative electrode active material, a binder, and a binder in a suitable solvent, and then coating the resulting coating liquid on a single surface or both surfaces of the current collector followed by drying.

When the negative electrode is one according to the present embodiment, the negative electrode active material and binder are not particularly limited if they are a compound used for a nonaqueous electrolyte secondary battery. As for the negative electrode active material, those capable of occluding or releasing lithium ions at lower potential than the positive electrode active material can be used. Among them, a metal, an alloy, oxide, phosphide, ceramics, sulfide, and lithium composite oxide containing, as a main component, a carbon material or a metal selected from silicon, tin, antimony, aluminum, magnesium, bismuth, and titanium is preferable in that they have excellent cycle life. Examples of the binder which may be used include, in addition to a polymer material containing fluorine, styrene-butadiene rubber (SBR), polypropylene (PP), polyethylene (PE), and carboxymethyl cellulose (CMC).

When the negative electrode is one according to the present embodiment, as at least a part of the negative electrode active material, those containing a metal element can be used among the negative electrode active materials that are used for a nonaqueous electrolyte secondary battery. As for the metal element, silicon, tin, and titanium are preferable. When silicon or tin is contained as a metal element, a metal, an alloy, or an oxide form is preferable. When titanium is contained as a metal element, those in the form of oxide or lithium composite oxide are preferable. Among them, the negative electrode active material containing metal silicon is preferable in that it has high discharge capacity. Tin oxide or lithium titanium composite oxide is preferable in that it has excellent service life characteristics. As for the lithium titanium composite oxide, those with lithium ion absorption potential of 0.4 V (against Li/Li⁺) or higher are preferable. Examples of the active material with lithium ion absorption potential of 0.4 V (against Li/Li⁺) or higher include lithium titanate with a spinnel structure (Li₄₊ₓTi₅O₁₂), and lithium titanate with a ramsdellite structure (Li₂₊ₓTi₃O₇). The lithium titanium oxide can be used either singly or in combination of two or more types. Further, titanium oxide which becomes lithium titanium oxide by charging and discharging (for example, TiO₂) can also be used as an active material.

With regard to a graphite-based carbon material, conductivity is lowered when only graphite with high alkali metal occluding property is used. Thus, it is preferable to use in combination a carbon material such as acetylene black or carbon black as a binder.

The negative electrode active material can be used as a mixture of several types. In such case, when the first negative electrode active material is a compound containing a metal element, the second negative electrode active material is not particularly limited if it is a negative electrode active material used for a nonaqueous electrolyte secondary battery. In addition to the compounds containing metal element described above, a carbon material such as graphite can be used.

Lithium titanium oxide preferably has an average primary particle diameter of 5 μm or less. When the average primary particle diameter is 5 μm or less, the effective area contributing to the electrode reaction is sufficient so that good high current discharge characteristics can be obtained.

Further, lithium titanium oxide preferably has a specific area of 1 m²/g to 10 m²/g. When the specific area is 1 m²/g or more, the effective area contributing to the electrode reaction is sufficient so that good high current discharge characteristics can be obtained. Meanwhile, when the specific area is 10 m²/g or less, the reaction with nonaqueous electrolyte is suppressed so that a decrease in charging and discharging efficiency or a gas generation during storage can be suppressed.

As for the binder, a polymer material containing fluorine can be used. Further, the binder preferably contains, as a raw material, at least one compound selected from vinylidene difluoride, tetrafluoroethylene, polychlorotrifluoroethylene, polyvinyl fluoride, ethylene, hexafluoropropene, tetrafluoroethylene copolymer, polyfluorovinylidene-hexafluoropropene copolymer, and polytetrafluoroethylene-hexafluoropropene copolymer.

When the negative electrode active material layer is 100% by mass, the mixing ratio of the negative electrode active material, conductive material, and binder is preferably in the range in which the negative electrode active material is between 70% by mass and 95% by mass, the conductive material is between 0% by mass and 25% by mass, and the binder is between 2% by mass and 10% by mass.

The current collector which may be used is not particularly limited if it is a conductive material. Examples thereof which may be used include a foil, a mesh, a punched metal, and lath metal made of copper, stainless, or nickel.

The conductive material can be used without specific limitations if it is a conductive material and is not dissolved at charging. Examples thereof which may be used include a carbon material such as acetylene black, carbon black, or graphite, a metallic material such as copper, aluminum, stainless, or titanium, a conductive ceramic material, and a conductive glass material. As a positive electrode conductive material, a carbon material such as acetylene black, carbon black, or graphite, a metallic material selected from aluminum and titanium, a conductive ceramic material, and a conductive glass material can be used.

4) Electrolyte

The nonaqueous electrolyte is produced by dissolving an electrolyte in a nonaqueous solvent. Examples of the nonaqueous solvent which may be used include ester, carbonate ester, and a sulfonate ester compound. Specific examples thereof include ethylene carbonate, propylene carbonate, ethyl methyl carbonate, diethyl carbonate, dimethyl carbonate, γ-butyrolactone, γ-valerolactone, α-acetyl-γ-butyrolactone, α-methyl-γ-butyrolactone, methyl acetate, ethyl acetate, methyl propionate, ethyl butyrate, butyl acetate, n-propyl acetate, isobutyl propionate, benzyl acetate, ethyl methanesulfonate, propyl methanesulfonate, methyl ethanesulfonate, propyl ethanesulfonate, methyl propanesulfonate, and ethyl propanesulfonate. It may be used either singly or in combination of two or more types. Among them, it is preferable that at least one nonaqueous solvent selected from ethylene carbonate, propylene carbonate, and γ-butyrolactone and least one nonaqueous solvent selected from ethyl methyl carbonate, diethyl carbonate, and dimethyl carbonate are used as a mixture.

It may be used either singly or in combination of two or more types. Among them, ethylene carbonate, propylene carbonate, ethyl methyl carbonate, and γ-butyrolactone are preferable. However, when an aliphatic carboxylic acid ester is contained from the viewpoint of gas generation, it is preferably in the range of 30% by weight or less, or 20% by weight or less in the entire nonaqueous solvent.

As for the nonaqueous solvent of the embodiment, any one of the following compositions is preferable, for example.

<Nonaqueous Solvent 1>

Nonaqueous solvent with total amount of 100% by volume containing 5% by volume to 50% by volume of ethylene carbonate and 50% by volume to 95% by volume of ethyl methyl carbonate.

<Nonaqueous Solvent 2>

Nonaqueous solvent with total amount of 100% by volume containing 5% by volume to 50% by volume of ethylene carbonate and 50% by volume to 95% by volume of diethyl carbonate.

<Nonaqueous Solvent 3>

Nonaqueous solvent with total amount of 100% by volume containing 5% by volume to 40% by volume of ethylene carbonate, 20% by volume to 80% by volume of propylene carbonate and 5% by volume to 40% by volume of γ-butyrolactone.

Meanwhile, when γ-butyrolactone or propylene carbonate is used as a main component, a chain-like carbonate ester such as diethyl carbonate, dimethyl carbonate, or ethyl methyl carbonate can be used for the purpose of lowering the viscosity and a cyclic carbonate ester such as ethylene carbonate can be used for the purpose of increasing the permittivity.

From the viewpoint of further enhancing the effect of inhibiting gas generation, the nonaqueous electrolyte is preferably added with at least one selected from a group consisting of a carbonate ester additive and a sulfur compound additive. It is believed that the carbonate ester additive has, due to film formation or the like, an effect of lowering gas like H₂ and CH₄ that is generated on a surface of the negative electrode, and the sulfur compound additive has, due to film formation or the like, an effect of lowering gas like CO₂ that is generated on a surface of the positive electrode.

Examples of the carbonate ester additive include vinylene carbonate, phenylethylene carbonate, phenylvinylene carbonate, diphenylvinylene carbonate, trifluoropropylene carbonate, chloroethylene carbonate, methoxypropylene carbonate, vinylethylene carbonate, catechol carbonate, tetrahydrofuran carbonate, diphenyl carbonate, and diethyl dicarbonate (diethyl bicarbonate). It may be used either singly or in combination of two or more types. Among them, from the viewpoint of having a high effect of lowering gas generated on a surface of the negative electrode, vinylene carbonate, phenylvinylene carbonate, or the like are preferable. Vinylene carbonate is particularly preferable.

Examples of the sulfur compound additive include ethylene sulfite, ethylene trithiocarboante, vinylene trithiocarbonate, catechol sulfite, tetrahydrofuran sulfite, sulfolane, 3-methylsulfolane, sulfolene, propane sultone, and 1,4-butane sultone. It may be used either singly or in combination of two or more types. Among them, from the viewpoint of having a high effect of lowering gas generated on a surface of the positive electrode, propane sultone, sulfolane, ethylene sulfite, catechol sulfite or the like are preferable. Propane sultone is particularly preferable.

The addition ratio of at least one selected from a group consisting of the carbonate ester additive and sulfur compound additive is, compared to the 100 parts by mass of the nonaqueous electrolyte, between 0.1 part by mass and 10 parts by mass, and preferably between 0.5 part by mass and 5 parts by mass in terms of total amount. When the addition ratio of those additives is lower than 0.1 part by mass, the effect of inhibiting gas generation is not much improved. On the other hand, when it is more than 10 parts by mass, the film formed on top of the electrode becomes excessively thick so that the discharge characteristics are impaired.

When the carbonate ester additive and sulfur compound additive are used in combination, their addition ratio (carbonate ester additive:sulfur compound additive) is preferably between 1:9 and 9:1 from the viewpoint of obtaining their effects in balance.

The addition ratio of the carbonate ester additive is, compared to the 100 parts by mass of the nonaqueous electrolyte, between 0.1 part by mass and 10 parts by mass, and preferably between 0.5 part by mass and 5 parts by mass. When the addition ratio is lower than 0.1 part by mass, the effect of reducing gas generation on the negative electrode is lowered. On the other hand, when it is more than 10 parts by mass, the film formed on top of the electrode becomes excessively thick so that the discharge characteristics are impaired.

The addition ratio of the sulfur compound additive is, compared to the 100 parts by mass of the nonaqueous electrolyte, between 0.1 part by mass and 10 parts by mass, and preferably between 0.5 part by mass and 5 parts by mass. When the addition ratio is lower than 0.1 part by mass, the effect of reducing gas generation on the positive electrode is lowered. On the other hand, when it is more than 10 parts by mass, the film formed on top of the electrode becomes excessively thick so that the discharge characteristics are impaired.

As for the electrolyte contained in a nonaqueous electrolyte solution, an alkali salt can be used.

Preferably, a lithium salt is used. Examples of the lithium salt preferably include at least one electrolyte salt selected from a group consisting of LiPF₄(CF₃)₂, LiPF₄(C2F₅)₂, LiPF₃(CF₃)₃, LiPF₃(C₂F₅)₃, LiPF₄(CF₃SO₂)₂, LiPF₄(C₂F₅SO₂)₂, LiPF₃(CF₃SO₂)₃, LiPF₃(C₂F₅SO₂)₃, LiBF₂(CF₃)₂, LiBF₂(C₂F₅)₂, LiBF₂(CF₃SO₂)₂, LiBF₂(C₂F₅SO₂)₂, LiPF₆, LiBF₄, LiSbF₆, and LiAsF₆.

Because the aforementioned compounds have very excellent thermal stability, they show little deterioration in battery properties when used at high temperature or after storage at high temperature and they have little gas generation caused by thermal decomposition. However, those compounds have a problem that they are vulnerable to a decomposition reaction on a positive electrode. Thus, by containing at least one electrolyte salt selected from a group consisting of LiPF₆, LiBF₄, LiSbF₆, and LiAsF₆, the salt reacts first on the positive electrode and forms a film with good quality on the positive electrode, and as a result, the decomposition reaction of the compounds on the positive electrode is suppressed.

5) Separator

When a nonaqueous electrolyte solution is used or an electrolyte impregnation type polymer electrolyte is used, a separator can be used. As a separator, a porous separator is used. The separator is made of a porous membrane of synthetic resin such as polytetrafluoroethylene, polypropylene or polyethylene, or a ceramic porous membrane, and it may also have a structure in which two or more porous membranes are laminated.

The thickness of the separator is preferably 30 μm or less. When the thickness is more than 30 μm, the distance between the positive electrode and negative electrode increases, and thus a high internal resistance may be caused. Further, the lower limit of the thickness is preferably 5 μm or less. When the thickness is less than 5 μm, the separator strength is significantly lowered so that an internal short circuit may easily occur. The upper limit of the thickness is more preferably 25 μm, and the lower limit is preferably 1.0 μm.

The thermal shrinkage ratio of the separator is preferably 20% or lower when it is kept for 1 hour under condition of 120° C. When the thermal shrinkage ratio is more than 20%, there is high possibility of having short circuit according to heating. The thermal shrinkage ratio is more preferably 15% or less.

Porosity of the separator is preferably in the range of 30% and 70%. The reasons are as follows. When the porosity is less than 30%, it may be difficult to have high electrolyte maintainability in a separator. On the other hand, when the porosity is more than 60%, sufficient separator strength may not be obtained. More preferred range of the porosity is in the range of 35% to 70%.

Air permeability of the separator is preferably 500 seconds/100 cm³ or less. If the air permeability is more than 500 seconds/100 cm³, it may be difficult to obtain high lithium ion mobility in the separator 204. Further, the lower limit of the air permeability is 30 seconds/100 cm³. If the air permeability is less than 30 seconds/100 cm³, it may be difficult to obtain sufficient separator strength.

The upper limit of the air permeability is preferably 300 seconds/100 cm³, and the lower limit of the air permeability is preferably 50 seconds/100 cm³.

### Third Embodiment

Next, the battery pack according to the third embodiment is described.

The battery pack according to the third embodiment has at least one nonaqueous electrolyte secondary battery (that is, unit battery) according to the second embodiment. When plural unit batteries are included in a battery pack, each unit battery is disposed in serial, parallel, or serial and parallel electric connection.

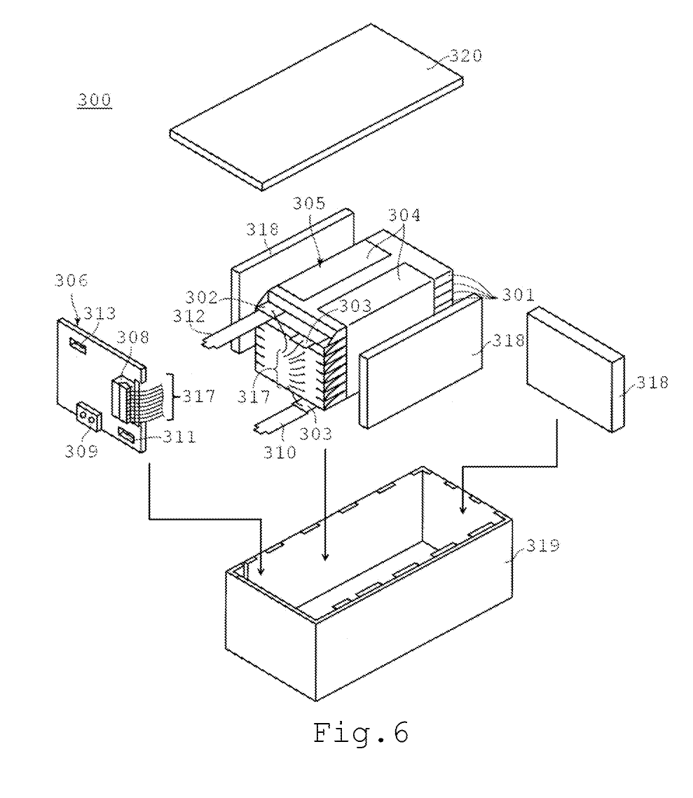

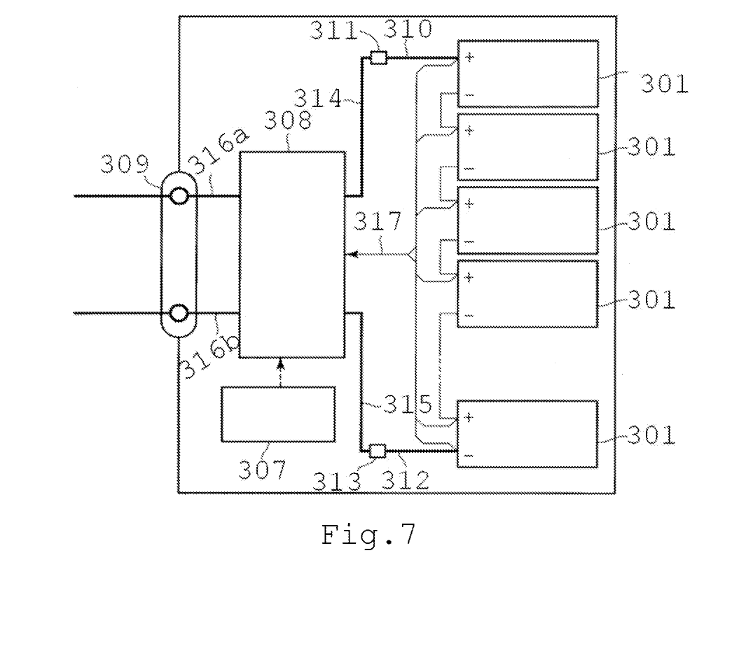

The battery pack 300 is specifically described in view of the schematic diagram of FIG. 6 and the block diagram of FIG. 7. In the battery pack 300 illustrated in FIG. 6, the flat type nonaqueous electrolyte solution battery 200 illustrated in FIG. 4 was used as the unit battery 301.

The plural unit battery 301 is laminated such that the negative electrode terminal 302 and the positive electrode terminal 303 extended to outside are provided in the same direction, and by clamping them with the adhesive tape 304, the set battery 305 is established. The unit batteries 301 are electrically connected to each other in series as illustrated in FIG. 5.

The printed circuit board 306 is disposed opposite to the lateral side of the unit battery 301 from which the negative electrode terminal 302 and the positive electrode terminal 303 are extended. The printed circuit board 306 is added with the thermistor 307, the protection circuit 308, and the terminal 309 for electric communication to an external device as illustrated in FIG. 7. Meanwhile, on surface of the protection circuit board 306 opposite to the set battery 305, an insulating plate for avoiding unnecessary connection to the set battery 305 is added (not illustrated).

The positive electrode side lead 310 is connected to the positive electrode terminal 303, which is located on the lowest layer of the set battery 305. Tip of the lead is inserted to the positive electrode side connector 311 of the printed circuit board 306 for electric connection. The negative electrode side lead 312 is connected to the negative electrode terminal 302, which is located on the uppermost layer of the set battery 305. Tip of the lead is inserted to the negative electrode side connector 313 of the printed circuit board 306 for electric connection. The connectors 311 and 313 are connected to the protection circuit 308 via the wires 314 and 315 that are formed on the printed circuit board 306.

The thermistor 307 is used for detecting the temperature of the unit battery 301, and the detected signal is sent to the protection circuit 308. The protection circuit 308 can, under predetermined conditions, cut off the plus side wire 316a and the minus side wire 316b that are present between the protection circuit 308 and the terminal 309 for electric communication to an external device. As described herein, the predetermined conditions indicate the temperature at which the detection temperature by the thermistor 307 is the same or higher than the predetermined temperature. Further, the predetermined conditions indicate a case wherein over-charge, over-discharge, or over-current is detected from the unit battery 301. Detection of the over-charge or the like is performed for each unit battery 301 or for the entire unit battery 301. For detecting each unit battery 301, battery voltage may be detected or potential of the positive electrode or potential of the negative electrode can be detected. In case of the latter, a lithium electrode used as a reference electrode is inserted to each of the unit battery 301. In FIG. 4 and FIG. 5, the wire 317 is connected to each of the unit battery 301 for voltage detection, and the detection signal is sent to the protection circuit 308 via the wire 317.

On each of the three lateral sides of the set battery 305 except the lateral side from which the positive electrode terminal 303 and the negative electrode terminal 302 extruded, the protection sheet 318 made of rubber or resin is disposed.

The set battery 305 is, together with each protection sheet 318 and the printed circuit board 306, accommodated within the accommodating container 319. Specifically, on each of the inner side surface in long side direction and the inner side surface in short side direction of the accommodating container 319, the protection sheet 318 is added. On the inner side surface opposite to the short side direction, the printed circuit board 306 is added. The set battery 305 is located in a space which is surrounded by the protection sheet 318 and the printed circuit board 306. The cover 320 is added on top of the accommodating container 319.

Meanwhile, for fixing the set battery 305, a thermal shrinking tape can be used instead of the adhesive tape 304. In such case, the protective sheet is added on both lateral sides of the set battery, and after applying a thermal shrinking tape, the thermal shrinking tape is shrunken by heat to clamp the set battery.

In FIG. 6 and FIG. 7, a mode of having the unit battery 301 connected in series is illustrated. However, to increase the battery capacity, connection can be made in parallel or in combination of serial connection and parallel connection. It is also possible that the combined battery packs are connected again in series or parallel.

According to the embodiments described above, a battery pack having excellent charging and discharging cycle performance can be provided by having a nonaqueous electrolyte secondary battery with excellent charging and discharging cycle performance as described in the third embodiment described above.

Meanwhile, the shape of the battery pack is suitably modified depending on use. As for the use of a battery pack, those exhibiting excellent cycle performance at high current extraction are preferable. Specific examples include those for power source of a digital camera, and those mounted in an electric vehicle such as a two-wheel or four-wheel hybrid electric vehicle, a two-wheel or four-wheel electric vehicle, or a power-assisted bicycle. In particular, the battery pack using a nonaqueous electrolyte secondary battery with excellent high temperature properties are preferably used for those mounted in a vehicle.

### Example 1

PVdF was used as a binder. As a result of the measurement using a thermogravimetric analyzer, the thermal decomposition temperature T1 was 450° C. and the thermal decomposition end temperature T2 was 500° C. According to the thermal decomposition gas chromatography mass analysis at 475° C., fragments with the mass number of 132 and 200 were present. As a positive electrode active material, Li(Ni_{5/10}Co_{2/10}Mn_{3/10})O₂ was used. As a binder, PVdF was used. As a conductive material, acetylene black was used. With the composition ratio of 80:5:15 in terms of weight ratio, a positive electrode was prepared. First, PVdF was dissolved in NMP to 10% by weight, added with acetylene black and zirconia beads, and introduced to a stirring vessel having two stirring wings and stirred for 30 minutes at 45° C. condition to prepare acetylene black paste. The acetylene black paste prepared was cooled to 25° C., removed from the vessel, and the zirconia beads were removed by filtration. Then, with the positive electrode active material, it was introduced again to a stirring vessel having two stirring wings and stirred for 30 minutes at 5° C. condition to prepare positive electrode slurry. The positive electrode slurry produced was coated on a copper foil by using an applicator, dried at 130° C. under atmospheric pressure, and then dried again at 150° C. under vacuum to manufacture a positive electrode.

An active material layer of the manufactured positive electrode was shaven. As a result of the thermal decomposition mass analysis, peaks are present with the mass number of 132 and 200 at thermal decomposition temperature of 475° C. and, when an ion chromatogram of the thermal decomposition mass analysis is depicted against each mass number, the peak with the mass number of 200 has the largest area.

From the ion chromatogram of mass number of 200 at 350° C. to 450° C. and 450° C. to 500° C., the area value (X) and area value (Y2) were calculated. They were shown to have a relation of X≦Y.

By using the obtained positive electrode, a negative electrode made of graphite, and a nonaqueous electrolyte solution, a nonaqueous electrolyte secondary battery was manufactured. By performing a charging and discharging cycle test at 25° C., the discharge capacity at the third cycle was determined.

### Example 2

A positive electrode was produced in the same manner as Example 1 except that LiCoO₂ is used as a positive electrode active material. Further, by using a negative electrode made of graphite and a nonaqueous electrolyte solution, a nonaqueous electrolyte secondary battery was manufactured. By performing a charging and discharging cycle test at 25° C., the discharge capacity at the third cycle was determined.

### Example 3

A positive electrode was produced in the same manner as Example 1 except that LiMn_{1.5}Ni_{0.5}O₄ is used as a positive electrode active material. Further, by using a negative electrode made of graphite and a nonaqueous electrolyte solution, a nonaqueous electrolyte secondary battery was manufactured. By performing a charging and discharging cycle test at 25° C., the discharge capacity at the third cycle was determined.

### Example 4

A positive electrode was produced in the same manner as Example 1 except that Li(Fe_{0.4}Mn_{0.6})PO₄ is used as a positive electrode active material. Further, by using a negative electrode made of graphite and a nonaqueous electrolyte solution, a nonaqueous electrolyte secondary battery was manufactured. By performing a charging and discharging cycle test at 25° C., the discharge capacity at the third cycle was determined.

### Example 5

A negative electrode was produced in the same manner as Example 1 except that Li₄Ti₅O₁₂ is used as a negative electrode material. Further, by using a counter electrode made of metal lithium and a nonaqueous electrolyte solution, a nonaqueous electrolyte secondary battery was manufactured. By performing a charging and discharging cycle test at 25° C., the discharge capacity at the third cycle was determined.

### Comparative Example 1

As a positive electrode active material, Li(Ni_{5/10}Co_{2/10}Mn_{3/10})O₂ was used. As a binder, PVdF was used. As a conductive material, acetylene black was used. With the composition ratio of 80:5:15 in terms of weight ratio, a positive electrode was prepared. First, PVdF was dissolved in NMP to 10% by weight, added with the positive electrode active material and zirconia beads, and introduced to a stirring vessel having two stirring wings and stirred for 30 minutes at 45° C. condition to prepare positive electrode active material paste. The positive electrode active material paste prepared was cooled to 25° C., removed from the vessel, and the zirconia beads were removed by filtration. Then, with acetylene black, it was introduced again to a stirring vessel having two stirring wings and stirred for 30 minutes at 5° C. condition to prepare positive electrode slurry. The positive electrode slurry produced was coated on a copper foil by using an applicator, dried at 130° C. under atmospheric pressure, and then dried again at 130° C. under vacuum to manufacture a positive electrode.

By using a negative electrode made of graphite, and a nonaqueous electrolyte solution, a nonaqueous electrolyte secondary battery was manufactured. By performing a charging and discharging cycle test at 25° C., the discharge capacity at the third cycle was determined and it was found to be 85% compared to Example 1.

### Comparative Example 2

A positive electrode was produced in the same manner as Comparative Example 1 except that LiCoO₂ is used as a positive electrode active material. Further, by using a negative electrode made of graphite and a nonaqueous electrolyte solution, a nonaqueous electrolyte secondary battery was manufactured. By performing a charging and discharging cycle test at 25° C., the discharge capacity at the third cycle was determined and it was found to be 88% compared to Example 2.

### Comparative Example 3

A positive electrode was produced in the same manner as Comparative Example 1 except that LiMn_{1.5}Ni_{0.5}O₄ is used as a positive electrode active material. Further, by using a negative electrode made of graphite and a nonaqueous electrolyte solution, a nonaqueous electrolyte secondary battery was manufactured. By performing a charging and discharging cycle test at 25° C., the discharge capacity at the third cycle was determined and it was found to be 80% compared to Example 3.

### Comparative Example 4

A positive electrode was produced in the same manner as Comparative Example 1 except that Li(Fe_{0.4}Mn_{0.6})PO₄ is used as a positive electrode active material. Further, by using a negative electrode made of graphite and a nonaqueous electrolyte solution, a nonaqueous electrolyte secondary battery was manufactured. By performing a charging and discharging cycle test at 25° C., the discharge capacity at the third cycle was determined and it was found to be 88% compared to Example 4.

### Comparative Example 5

A negative electrode was produced in the same manner as Comparative Example 1 except that Li₄Ti₅O₁₂ is used as a negative electrode material. Further, by using a counter electrode made of metal lithium and a nonaqueous electrolyte solution, a nonaqueous electrolyte secondary battery was manufactured. By performing a charging and discharging cycle test at 25° C., the discharge capacity at the third cycle was determined and it was found to be 78% compared to Example 1.

As described above, a nonaqueous electrolyte secondary battery with excellent discharge capacity can be manufactured by the embodiments.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electrode for a nonaqueous electrolyte secondary battery comprising:
an active material layer containing an active material and a binder containing fluorine; and
a current collector bound to the active material layer; wherein,
when a thermal decomposition start temperature of the binder is T1° C. and the thermal decomposition end temperature is T2° C., one or more signals are present for any of the mass number of 81, 100, 132, and 200 in a thermal decomposition mass analysis between thermal decomposition temperatures of T1 and T2; and
when a signal area of the mass spectrum in the range of T1-100° C. or higher but lower than T1° C. is X, and
a signal area of the mass spectrum in the range of T1 or higher but the same or lower than T2° C. is Y,
the X and Y satisfy a relation of X≦Y,
wherein the thermal decomposition start temperature of the binder indicates, in a main weight loss process, a temperature at which 5% of the weight loss portion in the weight loss process is reduced when the binder is analyzed by thermogravimetric analysis,
the thermal decomposition end temperature of the binder indicates, in a main weight loss process, a temperature at which 95% of the weight loss portion in the weight loss process is reduced when the binder is analyzed by thermogravimetric analysis, and
the signal area of mass spectrum indicates, in the mass spectrum of the binder, signal area of the mass number with maximum signal area between T1 and T2 among one or more signals selected from the mass number of 81, 100, 132, and 200.

2. The electrode according to claim 1, wherein the binder comprises, as a raw material, at least one compound selected from vinylidene difluoride, tetrafluoroethylene, polychlorotrifluoroethylene, polyvinyl fluoride, ethylene, tetrafluoroethylene copolymer, hexafluoropropene, polyfluorovinylidene-hexafluoropropene copolymer, and polytetrafluoroethylene-hexafluoropropene copolymer.

3. The electrode according to claim 1, wherein the binder is a polymer material selected from polytetrafluoroethylene, polyvinyldiene difluoride, polytetrafluoroethylene-vinylidene fluoride, and polyetetrafluoroethylene-hexafluoropropylene.

4. The electrode according to claim 1, wherein the active material layer further comprises a conductive material.

5. The electrode according to claim 1, wherein the active material comprises at least one compound selected from lithium composite oxide and a lithium composite phosphate compound which have at least charge end voltage of 4.0 V or higher against lithium reference potential.

6. The electrode according to claim 1, wherein the active material contains at least one element selected at least from silicon, tin, antimony, aluminum, magnesium, bismuth, and titanium in the form selected from metal, alloy, oxide, phosphide, ceramics, sulfide, and lithium composite oxide.

7. A nonaqueous electrolyte secondary battery comprising:
a negative electrode;
a positive electrode;
a nonaqueous electrolyte layer formed between the positive electrode and negative electrode, and a case for accommodating the positive electrode, negative electrode, and an electrolyte;
wherein at least one of the positive electrode and negative electrode comprise an active material layer containing an active material and a binder containing fluorine, and a current collector bound to the active material layer, and wherein,
when a thermal decomposition start temperature of the binder is T1° C. and the thermal decomposition end temperature is T2° C., one or more signals are present for any of the mass number of 81, 100, 132, and 200 in a thermal decomposition mass analysis between thermal decomposition temperatures of T1 and T2; and
when a signal area of the mass spectrum in the range of T1-100° C. or higher but lower than T1° C. is X, and
a signal area of the mass spectrum in the range of T1 or higher but the same or lower than T2° C. is Y,
the X and Y satisfy a relation of X≦Y,
wherein the thermal decomposition start temperature of the binder indicates, in a main weight loss process, a temperature at which 5% of the weight loss portion in the weight loss process is reduced when the binder is analyzed by thermogravimetric analysis,
the thermal decomposition end temperature of the binder indicates, in a main weight loss process, a temperature at which 95% of the weight loss portion in the weight loss process is reduced when the binder is analyzed by thermogravimetric analysis, and
the signal area of mass spectrum indicates, in the mass spectrum of the binder, signal area of the mass number with maximum signal area between T1 and T2 among one or more signals selected from the mass number of 81, 100, 132, and 200.

8. The secondary battery according to claim 7, wherein the binder comprises, as a raw material, at least one compound selected from vinylidene difluoride, tetrafluoroethylene, polychlorotrifluoroethylene, polyvinyl fluoride, ethylene, tetrafluoroethylene copolymer, hexafluoropropene, polyfluorovinylidene-hexafluoropropene copolymer, and polytetrafluoroethylene-hexafluoropropene copolymer.

9. The secondary battery according to claim 7, wherein the binder is a polymer material selected from polytetrafluoroethylene, polyvinyldiene difluoride, polytetrafluoroethylene-vinylidene fluoride, and polyetetrafluoroethylene-hexafluoropropylene.

10. The secondary battery according to claim 7, wherein the active material layer further comprises a conductive material.

11. The secondary battery according to claim 7, wherein the active material comprises at least one compound selected from lithium composite oxide and a lithium composite phosphate compound which have at least charge end voltage of 4.0 V or higher against lithium reference potential.

12. The secondary battery according to claim 7, wherein the active material contains at least one element selected at least from silicon, tin, antimony, aluminum, magnesium, bismuth, and titanium in the form selected from metal, alloy, oxide, phosphide, ceramics, sulfide, and lithium composite oxide.

13. A battery pack comprising:
a nonaqueous electrolyte secondary battery,
wherein the nonaqueous electrolyte secondary battery comprises a negative electrode, a positive electrode, a nonaqueous electrolyte layer formed between the positive electrode and negative electrode, and a case for accommodating the positive electrode, the negative electrode, and an electrolyte;
wherein at least one of the positive electrode and negative electrode comprise an active material layer containing an active material and a binder containing fluorine, and a current collector bound to the active material layer, and wherein,
when a thermal decomposition start temperature of the binder is T1° C. and the thermal decomposition end temperature is T2° C., one or more signals are present for any of the mass number of 81, 100, 132, and 200 in a thermal decomposition mass analysis between thermal decomposition temperatures of T1 and T2; and
when a signal area of the mass spectrum in the range of T1-100° C. or higher but lower than T1° C. is X, and
a signal area of the mass spectrum in the range of T1 or higher but the same or lower than T2° C. is Y,
the X and Y satisfy a relation of X≦Y,
wherein the thermal decomposition start temperature of the binder indicates, in a main weight loss process, a temperature at which 5% of the weight loss portion in the weight loss process is reduced when the binder is analyzed by thermogravimetric analysis,
the thermal decomposition end temperature of the binder indicates, in a main weight loss process, a temperature at which 95% of the weight loss portion in the weight loss process is reduced when the binder is analyzed by thermogravimetric analysis, and
the signal area of mass spectrum indicates, in the mass spectrum of the binder, signal area of the mass number with maximum signal area between T1 and T2 among one or more signals selected from the mass number of 81, 100, 132, and 200.

14. The battery pack according to claim 13, wherein the binder comprises, as a raw material, at least one compound selected from vinylidene difluoride, tetrafluoroethylene, polychlorotrifluoroethylene, polyvinyl fluoride, ethylene, tetrafluoroethylene copolymer, hexafluoropropene, polyfluorovinylidene-hexafluoropropene copolymer, and polytetrafluoroethylene-hexafluoropropene copolymer.

15. The battery pack according to claim 13, wherein the binder is a polymer material selected from polytetrafluoroethylene, polyvinyldiene difluoride, polytetrafluoroethylene-vinylidene fluoride, and polyetetrafluoroethylene-hexafluoropropylene.

16. The battery pack according to claim 13, wherein the active material layer further comprises a conductive material.

17. The battery pack according to claim 13, wherein the active material comprises at least one compound selected from lithium composite oxide and a lithium composite phosphate compound which have at least charge end voltage of 4.0 V or higher against lithium reference potential.

18. The battery pack according to claim 13, wherein the active material contains at least one element selected at least from silicon, tin, antimony, aluminum, magnesium, bismuth, and titanium in the form selected from metal, alloy, oxide, phosphide, ceramics, sulfide, and lithium composite oxide.
